(19) United States
(12) Patent Application Publication
(10) Pub. No.: US 2004/0125993 A1
(43) Pub. Date: Jul. 1, 2004

(54) Fingerprint security systems in handheld electronic devices and methods therefor

(76) Inventors: Yilin Zhao, Northbrook, IL (US); Peter Zhen-Ping Lo, Lake Forest, CA (US); Harshawardhan Wabgaonkar, Lake Forest, CA (US)

Correspondence Address: MOTOROLA INC, 600 NORTH US HIGHWAY 45, ROOM AS437, LIBERTYVILLE, IL, 60048-5343, US

(21) Appl. No.: 10/331,515

(22) Filed: Dec. 30, 2002

(51) Int. Cl. G06K 9/00; H04Q 1/00

(52) U.S. Cl. 382/124; 340/5.53

(57) ABSTRACT

Fingerprint image processing methods for fingerprint security systems, for example, in wireless communications devices, including capturing fingerprint images (320), identifying features from images (330), matching the identified features with reference features (340), and providing access to the device based upon feature matching (350) results. In one embodiment, minutiae features are extracted from the image and matched to reference minutiae features.

### FIELD OF THE INVENTIONS

The present inventions relate generally to biometric security features in electronic devices, and more particularly to fingerprint image detection, processing and verification in electronic devices, for example in wireless communications handsets and other mobile devices, and methods therefor.

### BACKGROUND OF THE INVENTIONS

Electronic password based security schemes are commonly used to discourage and limit unauthorized use of electronics devices, including cellular phones, personal digital assistants (PDAs) and laptop computers, etc.

It is also known to use fingerprint identification as a means for preventing unauthorized use of electronic devices, as disclosed for example in U.S. Pat. No. 6,141,436 entitled “Portable Communication Device Having A Fingerprint Identification System”.

In many small-scale applications, like wireless communications handsets, it is desirable to use relatively small sensors, but small sensors are usually capable of capturing only limited portions of fingerprint information, which may be insufficient to ensure fingerprint verification accuracy and reliability. Optical sensors are large, consume relatively large amounts of power and may be too fragile for many applications, for example, in portable handheld devices.

U.S. Pat. No. 5,960,101 entitled “Expert Matcher Fingerprint System” discloses a system and method for fingerprint identification, which matches minutiae of an unknown, or search, fingerprint with minutiae of a known, or file, fingerprint based upon a comparison of coordinate locations and angles of rotation of the search and file fingerprint minutiae.

Current fingerprint technology generally requires more memory and many more instructions per second (MIPS) than most lower cost, portable devices and applications are capable of providing. In some applications, improvements in processing efficiency will reduce memory and processing requirements and time and hasten the implementation of fingerprint security systems in applications and devices having limited memory and processing resources, like wireless communications handsets, and in other lower cost products and applications.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is a schematic block diagram of an electronics device in which a fingerprint detection security system is implemented.

FIG. 2 is an exemplary electronics handset having a fingerprint detection security feature.

FIG. 3 is a schematic block diagram of an exemplary algorithm for implementing a fingerprint-based security system.

FIG. 4 is a schematic block diagram of an exemplary fingerprint image processing flow diagram.

FIG. 5 is an exemplary fingerprint image after pre-processing.

FIG. 6 is an iteratively enhanced fingerprint image.

FIG. 7 is a skeletonized fingerprint image.

FIG. 8 is a skeletonized fingerprint image with corresponding minutiae identified by circles.

FIG. 9 is a fingerprint minutia feature at a ridge termination point and neighboring fingerprint ridges.

FIG. 10 is a fingerprint minutia feature at a ridge bifurcation and neighboring fingerprint ridges.

FIG. 11 illustrates true and false fingerprint minutiae confidence distributions and a corresponding confidence threshold.

FIG. 12 is an exemplary search fingerprint minutiae set.

FIG. 13 is an exemplary file fingerprint minutiae set.

FIG. 14 is an exemplary alignment of the search and file fingerprint minutiae sets of FIGS. 12 and 13.

FIG. 15 is an exemplary fingerprint minutiae matching process flow diagram.

FIG. 16 is an exemplary fingerprint enrollment process flow diagram.

### DETAILED DESCRIPTION OF THE INVENTIONS

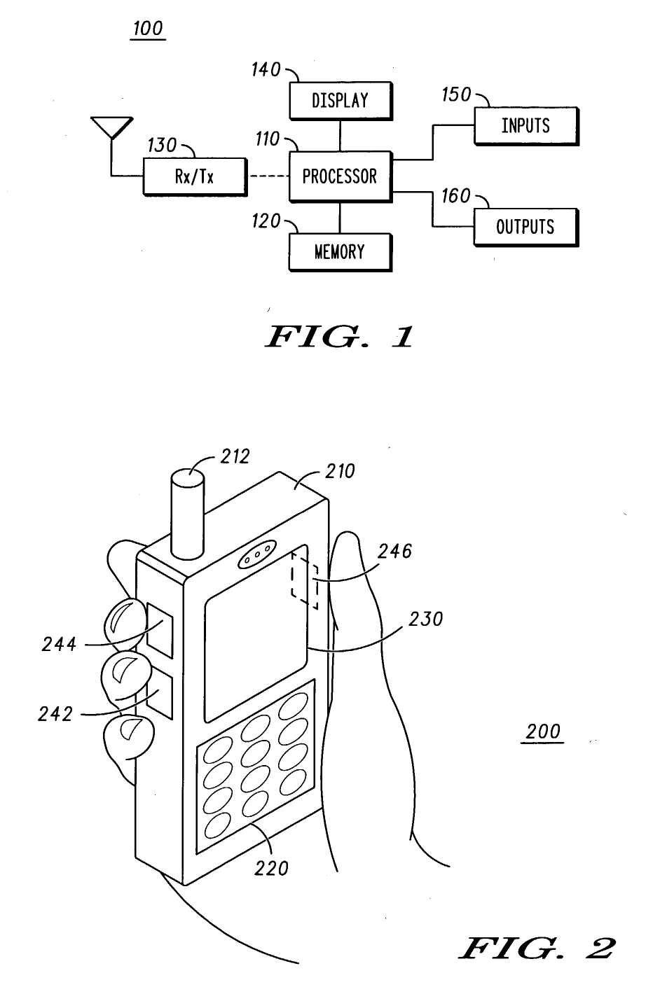

In FIG. 1, an electronics device 100 includes generally a processor 110 coupled to memory 120, which may include, for example, RAM, ROM, EEPROM, FLASH memory, and other memory devices and firmware. The memory stores instructions for operating the device, and device applications, including fingerprint processing and matching software for implementing aspects of the invention, which are discussed more fully below.

The exemplary electronics device 100 is a wireless communications handset comprising a transceiver 130 coupled to the processor 110, wherein the transceiver enables wireless communications, for example, over cellular communications network. In other embodiments, however, the electronics device 100 includes only a receiver. In still other embodiments, the electronics device 100 does not include a transceiver at all, for example, in personal organizers and other devices. The electronics device 100 may be a personal digital assistant (PDA) or a laptop computer, or some other handheld or mobile device, anyone of which may or may not include the transceiver 130.

More generally, the electronics device 100 may be any electronics device in which it is desirable to implement fingerprint-based security. These applications include, for example, general-purpose computers, or electronics devices embedded in larger systems, for example, in automobiles, access-locking systems, etc., among many other applications.

In FIG. 1, the exemplary communications device 100 also includes a display 140 coupled to the processor, but other embodiments may not include a display. The device 100 includes inputs 150 coupled to the processor, for example, a keyboard/pad, a scrolling or other input devices, possibly a microphone, and one or more fingerprint detectors, among other input devices. Outputs 160 are also coupled to the processor. The exemplary communications device 200 includes, for example, an audio speaker. Generally, the input and output devices are specific to the particular electronics device and the examples provided are not intended to limit the invention, although fingerprint secured devices will generally include at least one fingerprint sensor as one of the inputs.

Alternatively, in the circuit block diagram of FIG. 1, the processor, memory and input and output devices, may be primarily that of a fingerprint security system, wherein the input device includes at least a fingerprint sensor and the output device includes at least a control signal output producing device that indicates whether there is a fingerprint match. In this exemplary embodiment, other portions of the circuitry may not be required, for example the display and transceiver.

FIG. 2 is an exemplary wireless communications handset 200 comprising generally a housing 210 for housing electronics circuitry, for example the electronics device of FIG. 1. The exemplary handset 200 includes an antenna 212 which may also be internal, a keypad 220 and a display 230.

The electronic device includes at least one fingerprint detector, which is one of the inputs 150 in the architecture of FIG. 1. The one or more fingerprint detectors are disposed on the handset housing, preferably accessible from an outer side of the housing, for example, exposed on the housing as illustrated in FIG. 2 or upon displacing a fingerprint detector cover. In FIG. 2, first and second fingerprint detectors 242 and 244 are disposed on one side of the housing, and a third fingerprint detector 246 is disposed on an opposite side of the housing. Alternatively, the fingerprint detectors may be disposed on either front or back of the device 200 or on other parts of the housing. The number of the fingerprint detectors used depends generally on the size of the detector and on the detection accuracy required, as well as on human ergonomic criteria.

In the exemplary communications device 200 and in many other applications, especially handheld electronics devices, the one or more fingerprint detectors are relatively small. In one embodiment, for example, the fingerprint detector is approximately 1.52×1.52 cm² and includes approximately 256×300 pixels. Exemplary non-optical fingerprint detectors suitable for these exemplary handset device applications include pressure sensitive capacitive sensors available from Fujitsu, Ltd., for example, the Fujitsu MBF110 and MBF 200 solid-state fingerprint sensors, among other available sensors. In other embodiments the fingerprint detectors may be relatively large.

In applications where the fingerprint detector captures limited fingerprint portions, due to small detector size or due to other non-size related reasons, fingerprint verification accuracy may be compromised. For example, relatively small fingerprint detectors generally capture limited fingerprint portions, which may adversely affect detection integrity and reliability. Circumstances other than small detector size may also contribute to the detection of relatively small fingerprint portions.

In some embodiments, fingerprint detection accuracy is improved by detecting more than one fingerprint with a corresponding plurality of fingerprint detectors, for example, any combination of two or three of the fingerprint detectors 242, 244 or 246 illustrated in FIG. 2. Exemplary detection criteria may include matching at least one of two or three different fingerprints detected with corresponding sensors, or matching at least two of three different fingerprints detected with corresponding sensors or detectors, etc.

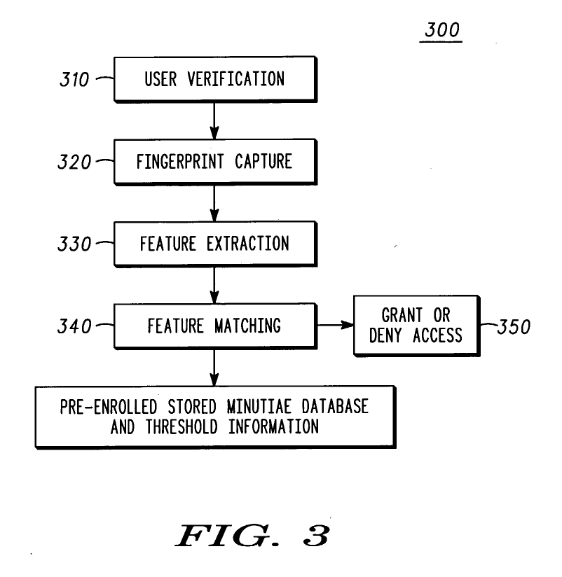

Generally, fingerprint security is based upon comparing an input fingerprint with a known reference fingerprint, also referred to herein as a “file fingerprint”, which may be stored on the device or at some other location. FIG. 3 is a schematic block diagram of a typical process block flow diagram or algorithm for implementing a fingerprint-based security system, and more particularly for processing fingerprint information and determining whether input fingerprint information matches known file fingerprint information. The algorithm is preferably implemented as a computer program, for example, as fingerprint security application software or some other computer code stored in memory and executable by a digital processor.

In FIG. 3, at block 310, a user verification mode is entered whereupon the system waits for the input of fingerprint information from a user, for example by touching one or more fingerprint sensors. At this stage of operation, user access to the device or system protected by the fingerprint security system is prohibited. The user verification mode may be entered whenever the device is powered “ON”, and in some embodiments the user verification mode is entered after the device has been inactive for some pre-determined time period, for example, after the device remains idle for some time period, or when a cellular telephone enters a sleep mode.

In FIG. 3, at block 320, fingerprint image information is captured, for example, upon contacting one or more fingerprint detectors with one or more corresponding fingers. In the exemplary embodiment of FIG. 2, fingerprint information is captured by at least one non-optical fingerprint sensor, although more generally the fingerprint information may be input to some other fingerprint detector, for example, an optical fingerprint detector, among other devices.

The fingerprint image capture stage is characterized generally by the digitization of fingerprint information input to the sensor. In one embodiment, the digitized fingerprint information is in the form of a gray-scale image described by a rectangular (M×N) pixel array, wherein each pixel of the array is assigned a gray-scale intensity value, for example, a value between 0-255 specified by a corresponding 8-bit number. In the exemplary electronics device handset application, typical pixel array values for M and N range between approximately 256 and 512 at a 500 dot-per-inch (dpi) pixel resolution. Initially, the gray-scale image has generally low contrast, smudges and ridge artifacts.

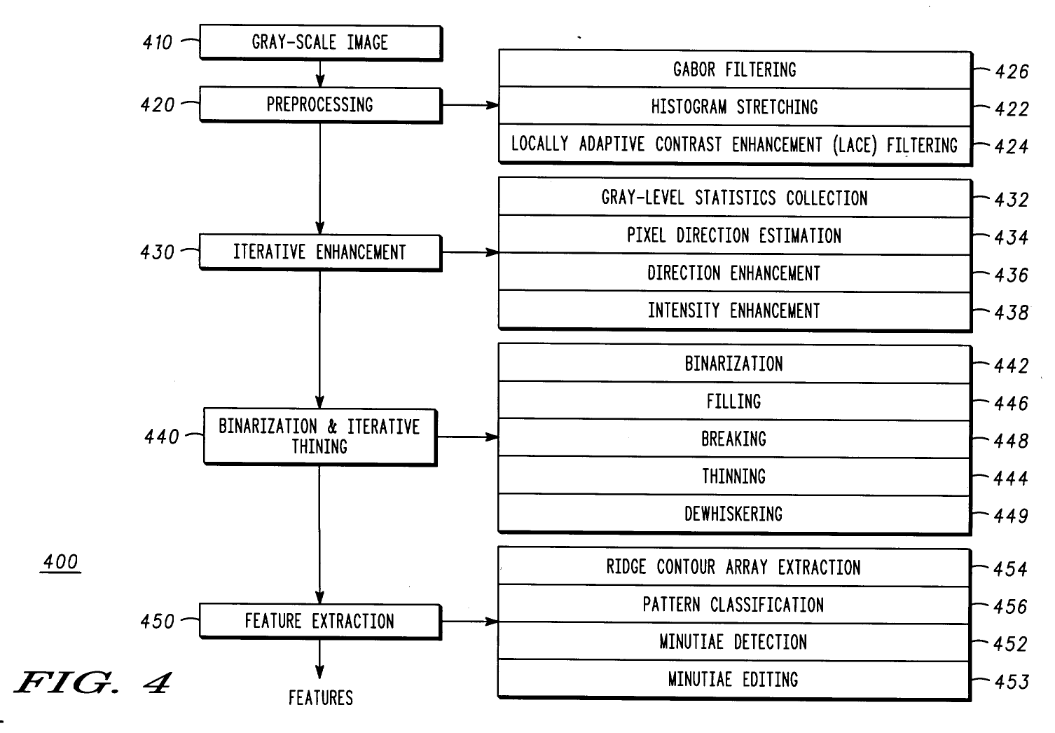

In FIG. 4, at block 410, in some applications, a gray scale image is subject to pre-processing at block 420 prior to fingerprint feature extraction, which is discussed more fully below. Pre-processing generally includes normalization and/or conditioning the gray-scale image for subsequent processing. In one embodiment, gray-scale image pre- processing includes increasing the range of intensity values of the gray-scale fingerprint image pixels in a process referred to as histogram stretching, identified at block 422 in FIG. 4. The dynamic range of the gray-scale image is enhanced to increase, and preferably to maximize, the range of the pixel intensity values, for example, in the exemplary range of 0-255 discussed above.

In some embodiments, gray-scale image pre-processing includes contrast enhancing of the gray-scale image, for example, by applying a gain that is inversely proportional to pixel image contrast. Pixel contrast may be estimated in terms of a variance of intensity values of neighboring pixels. In FIG. 4, at block 424, the contrast enhancement process is referred to as Locally Adaptive Contrast Enhancement (LACE) filtering, which may be performed alone or in combination with histogram stretching, which was discussed above in connection with block 422.

In some embodiments, gray-scale image pre-processing also includes the enhancement of fingerprint ridge frequency details, for example, by convolving the gray-scale image with a sinusoidally-modulated Gaussian kernel, also known as a Gabor kernel, in a process referred to as Gabor filtering at block 426 in FIG. 4. Gabor filtering may be performed alone or in combination with histogram stretching and LACE filtering.

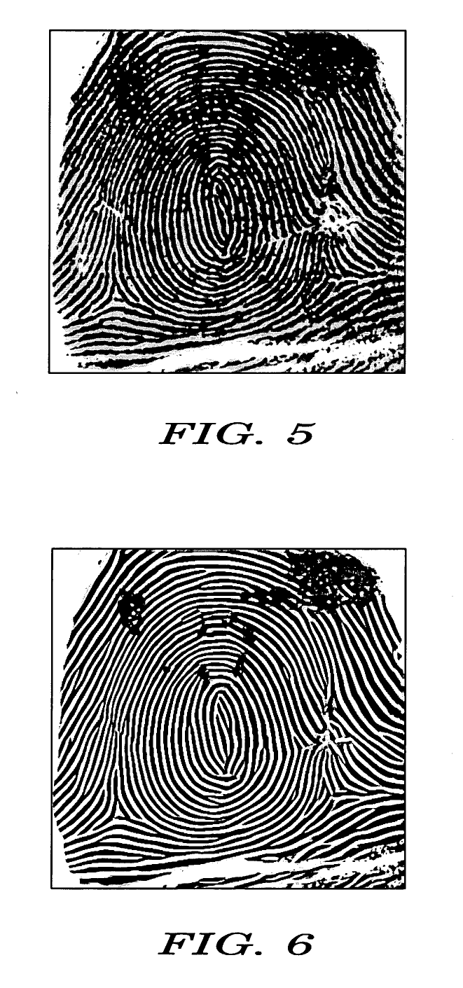

FIG. 5 illustrates a typical fingerprint image after pre-processing, which generally improves image contrast, and removes some smudges and artifacts typical of the original fingerprint image.

In FIG. 4, at block 430, in some applications, the gray-scale image is subject to iterative enhancement processing, either alone or combination with pre-processing conditioning, to produce an intensity enhanced, gray-scale image prior to minutia extraction or identification. The iterative enhancement processing involves several iterations of one or more of several functions discussed below.

In FIG. 4, at block 432, one iterative enhancement process function is the collection of gray-level statistics, which includes the determination of low and high (e.g., 10 and 90 percentile) dynamic ranges and a mean dynamic range of an L×L window neighboring each pixel of the gray-scale image. Pixels having a sufficiently low local dynamic range and a sufficiently high local mean are classified as “white” pixels, also referred to as background pixels. Thresholds for the low and high local dynamic ranges and the mean may be determined empirically.

In FIG. 4, at block 434, another iterative enhancement function is the determination of the direction of fingerprint ridge flows at each pixel in a process referred to as pixel direction estimation. A direction value is assigned to each pixel based on a summation of absolute values of the differences of pixel intensity values along a set of different directions. The direction along which the sum has a minimum value is chosen as the pixel direction. The direction values of the image pixels constitute a direction image map. A null direction value may also be assigned to some of the pixels previously identified as being non-white. In some embodiments, the direction of any white pixels is not determined, and thus gray-level statistics collection may be used to reduce direction value processing, although in some embodiments gray-level statistics collection is not performed.

In FIG. 4, at block 436, the direction image map generated previously, at block 434, is refined, and more particularly the direction of each pixel is refined based upon a statistical analysis of the direction of neighboring pixels.

In FIG. 4, at block 438, the pixel intensity is enhanced based upon the refined direction image map generated previously, at block 436. Particularly each pixel having a pixel direction is intensity-enhanced based upon the directions and intensities of neighboring pixels. Pixels having no direction are enhanced based upon a statistical analysis of the gray-levels of neighboring pixels. The intensity enhanced direction image map may be subject to several iterations of the sequence of processes in one or more of blocks 432, 434, 436 and 438 of FIG. 4.

FIG. 6 illustrates an intensity-enhanced image map after several enhancement iterations of gray-level statistics collection, pixel direction estimation, direction and intensity enhancement as discussed above with reference to block 430 of FIG. 4. The intensity enhanced image of FIG. 6 is improved substantially relative to the post pre-processing fingerprint image illustrated in FIG. 5.

In FIG. 4, at block 440, in some embodiments, the intensity enhanced direction image map produced at block 430 is subject to binarization and iterative thinning. At block 442, the intensity-enhanced image map is binarized using a thresholding operation. Particularly, pixels having an intensity value above a pre-defined threshold are assigned a value “1”, and pixels having a threshold value below the pre-defined threshold are assigned a value “0”, thus forming a binary image. In other fingerprint processing schemes the image is not binarized.

After image binarization, in some embodiments, the binary image is skeletonized or thinned. Thinning is performed generally by reducing the ridge widths to not more than one pixel wide, as indicated at block 444 in FIG. 4. In some applications, at block 446, broken ridges are filled before thinning. Also, in some applications, at block 448, weak bridges are broken before thinning. At block 449, in some applications, ridges shorter than some pre-determined length are erased in a de-whiskering operation. The filling and breaking and thinning processes may be performed iteratively.

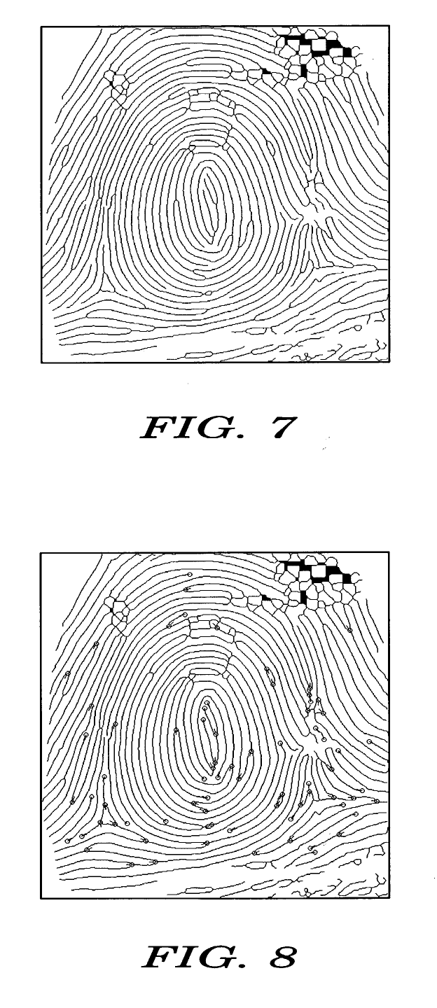

FIG. 7 illustrates an exemplary skeletonized image subject to filling, breaking, thinning and de-whiskering, as discussed above with reference to FIG. 4. Not all image irregularities and processing artifacts are necessarily removed from the image after binarization and thinning, as illustrated in the upper right corner of the skeletonized image of FIG. 7. A skeletonized image is one of several features extracted from fingerprint images for use in fingerprint matching, as discussed further below.

In FIG. 3, at block 330, fingerprint features are obtained from the fingerprint image, which in some embodiments is preferably enhanced and binarized, as discussed above, depending upon the fingerprint features to be extracted. Determination of the skeletonized or thinned feature was discussed above. Other features that may be extracted or identified include fingerprint minutiae features and fingerprint pattern features, both of which are discussed more fully below.

Fingerprint minutiae are micro-features that represent abrupt changes in local ridge flow. Each minutia is defined as either the termination point of a ridge, or as the bifurcation or branching point of a ridge. Each fingerprint minutia is typically described by its location coordinates, tail angle, and optionally by its type, i.e., whether it is a ridge ending or a ridge bifurcation. Minutiae detection is performed on the skeletonized image by traversing the thinned ridges to identify ridge endings and bifurcation points where branching occurs. FIG. 8 illustrates a skeletonized image having its minutiae identified by small circles.

Not all minutiae identified initially are true fingerprint minutiae, since some of the minutiae will result from artifacts of image processing prior to minutiae identification. Thus in applications it is desirable to eliminate minutiae that are most likely false minutiae.

In one embodiment, confidence information is determined for the minutiae. Particularly, a confidence factor or value is assigned to each minutia, for example, based upon one or more criteria. In one embodiment the confidence information is based upon pixel direction in a neighborhood of the corresponding minutia. The concept of pixel direction and the determination thereof is known generally in the art. Other factors upon which the confidence factor may be based include ridge continuity in the neighborhood of the corresponding minutia.

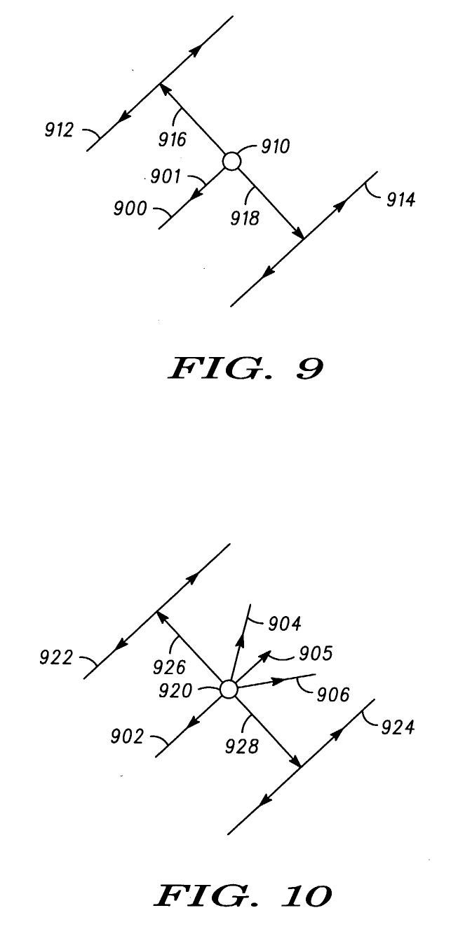

In one embodiment, the confidence factor is based upon the continuity of a ridge connected to or extending from the corresponding minutia. In FIG. 9, for example, the continuity of a ridge 900 terminating at a minutia 910 forms the basis for the confidence factor. In FIG. 10, the continuity of one or more ridges 902, 904 and 906 branching from a minutia 920 forms the basis for the confidence factor. The continuity of the ridges extending from the minutia is measured in an empirically determined neighborhood of the minutia.

The minutia confidence factor, may also be based upon the continuity of ridges connected to the minutia and ridges neighboring the minutia. In a preferred embodiment, the confidence information is based upon pixel direction in the neighborhood of each minutia, the continuity of ridges connected to each minutia, and the continuity of ridges neighboring each minutia.

In one embodiment, neighboring ridges are identified by searching along lines extending perpendicularly from the direction of a ridge connected to the minutia. In FIG. 9, the direction of the ridge 900 is specified by arrow 901, which extends from the minutia where the ridge is connected thereto. In FIG. 9, ridges 912 and 914 neighbor the minutia 910, and the continuity of the ridges 912 and 914 may be measured in both directions from the point at which the perpendicular arrows 916 and 918 extend from the minutia 910.

In FIG. 10, the ridge direction is determined by bisecting the smallest angle between ridges extending from the minutia. In FIG. 10, the smallest angle is between ridge 904 and ridge 906, and thus the ridge direction is specified by arrow 905 bisecting the angle between the ridges. In FIG. 10, ridges 922 and 924 neighbor the minutia 920, and the continuity of the ridges is measured in both directions from the point at which the perpendicular arrows 926 ands 928 extend from the minutia.

The minutia confidence factor may be used to distinguish between real and artificial or false minutiae that result from image processing. To make the distinction, the confidence factor is compared to a confidence threshold. Minutiae having a confidence factor below the threshold are identified as false and may be discarded, thereby reducing or refining the minutiae associated with the fingerprint image.

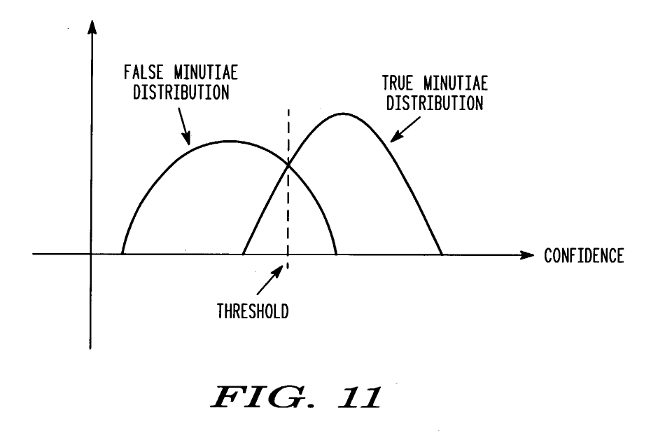

In one embodiment, the confidence threshold is determined based upon the number of minutiae detected and based upon empirical statistical distributions of the confidence information. FIG. 11 illustrates exemplary statistical distributions, for example, histograms, of true and false minutiae confidence information. In one embodiment, the confidence threshold is determined based upon the intersection of the true and false confidence information distributions. The confidence threshold thus varies depending upon the relative distributions of the true and false confidence information.

In some embodiments, the minutiae confidence factors are compared to a dynamically variable confidence threshold, which changes based upon the number of minutiae identified. For example, if the total number of detected minutiae is less than a predetermined reference number of minutiae, R, a first confidence threshold, T1, is selected. If the total number of minutiae is greater than the reference number R and less than a reference number S, a second threshold, T2, is selected. The second reference, T2, will generally be greater than the first reference, T1. If the total number of minutiae is greater than the second reference number S and if all of the minutiae greater than the reference number S have a confidence value greater than T2, the confidence threshold selected is set to the lowest confidence factor of the minutiae in the set of minutiae greater than the reference number S. Otherwise the confidence threshold is set to T2. If the selected threshold, T, is greater than some maximum threshold, T_{MAX}, then the threshold is set to the maximum threshold, T_{MAX}.

For a 512×512 pixel image, R=30 and S=130. The thresholds may be determined based upon empirical data, as discussed above. Other schemes for computing the dynamic threshold may also be used, and alternative schemes for obtaining empirically derived thresholds may be used, provided they maximize the selection of true minutiae and minimize the selection of false minutiae. For one exemplary application, the first, second and maximum thresholds are 50, 70 and 85, respectively. Any minutiae having a confidence factor greater than the confidence threshold are selected as true minutia and are used for subsequent processing. Other minutiae are disregarded.

The minutiae may also be assessed for validity by comparing the minutiae identified initially from a fingerprint image, for example, the minutiae of FIG. 7, with minutiae of a negative image of the fingerprint image. Any minutiae not having corresponding minutiae in the negative fingerprint image may be regarded as false and thus eliminated. In some applications, it desirable to first select a subset of true minutiae from the minutiae identified based on the confidence information, as discussed above, and then eliminate additional minutiae from the selected true minutiae subset not having corresponding minutiae in the fingerprint image negative.

The initial set of minutiae identified from a skeletonized image may thus be refined using the confidence information and/or in some embodiments by comparing the minutiae with a negative image of the fingerprint image to obtain a high quality set of true minutiae. In FIG. 4, minutiae identification or detection is indicated in block 452, and minutiae refinement or editing is indicated at block 453. In one embodiment, the fingerprint minutiae feature is used for fingerprint matching by matching search minutiae with known file minutiae. Other features may also be used for the fingerprint matching process, including the thinned image discussed above and fingerprint pattern information discussed further below.

Features other than minutiae may also be extracted from the fingerprint image, as illustrated generally in FIG. 4, at block 450. In some embodiments, the direction image is further smoothed and summarized in an array, for example a 32×32 array, of pixel directions, wherein each new pixel summarizes or represents the directions in the 32×32 array neighboring the pixel. At block 454, the resulting 32×32 array of ridge directions is referred to as a ridge contour array (RCA). At block 456, in some applications, the ridge contour array is classified into one of several classes, including, whorl, right or left loop, arch or tented arch. The classification may be performed by fingerprint pattern classifier software, which generally requires that the quality of the ridge contour array exceed some level. The pattern class may be used to assist fingerprint matching by matching search pattern features with known file pattern features.

In FIG. 3, at block 340, one or more reference fingerprint features are compared with corresponding search fingerprint features (from the fingerprint to be verified) to determine whether there is a fingerprint match. The matching process may be performed at the location of the fingerprint detector, for example, on the electronics device, or alternatively at some other location, for example, in a wireless communication network security server or some other location upon transmission of the fingerprint feature data thereto.

At block 350, some action is generally taken based upon whether or not there is a fingerprint match, for example, the user may or may not be granted access to the electronics device or other activity protected by the fingerprint security system, depending upon whether one or more search fingerprint features match known file fingerprint features.

In one embodiment, fingerprint feature matching is based upon a comparison of the minutiae of a newly acquired fingerprint, referred to as the “search print”, with the minutiae of one or more stored prints, referred to as the “file print”. The degree of the similarity between a pair of search and file fingerprint minutiae is quantified in terms of an output match score. The higher the score, the greater the similarity between the file and search fingerprints. The minutiae match score may also be used with the comparison of other fingerprint features, including pattern and skeletal features discussed above, demographic information, passwords, etc., to reliably verify an individual's identity.

As noted, fingerprint minutiae are micro-features extracted from a fingerprint image. Each minutia is characterized generally by position coordinates (x, y) and tail angle (theta), among other information. Depending on the source of a fingerprint image, the number of minutiae can vary from about 5-32, for example, for a print lifted from a crime-scene, to about 90-150 for a print from a fingerprint-scanning machine or from a finger print card. In applications using the exemplary 1.52×1.52 cm² detector having approximately 256×300 pixels, the minutiae number is expected to be in the range of about 30-100.

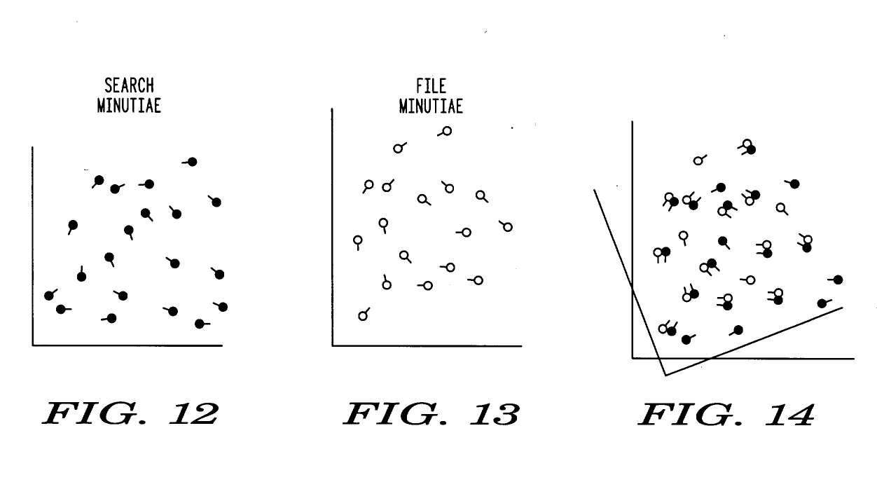

The minutiae matching process is performed generally by determining a degree of alignment of one or more optimal coarse-level orientations of the minutiae sets. FIG. 12 illustrates an exemplary search minutiae set and FIG. 13 illustrates an exemplary file minutiae set. In FIG. 14, the search and file minutiae sets are aligned in different orientations by rotating and translating the minutiae sets in the x and y directions. Each of these coarse-level orientations is then applied to the minutiae, and for each orientation the best-oriented search and file minutiae are compared in terms of the respective minutia neighborhoods to obtain a match score or some other measure of alignment. The maximum score for all of the best orientations is finally reported.

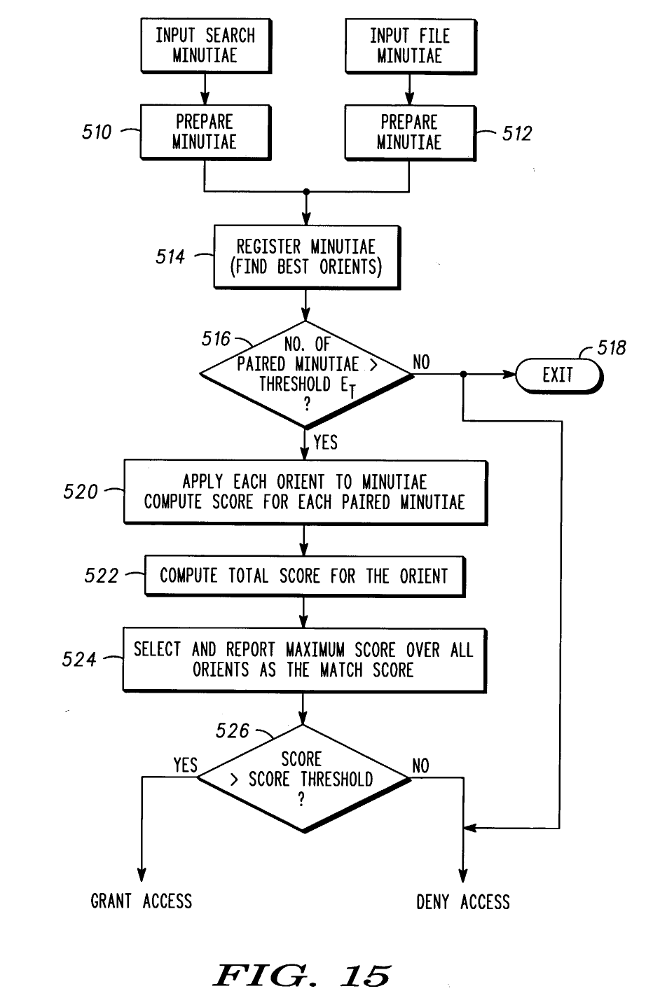

In one embodiment, the process is implemented wholly using integer arithmetic. One or more orientations of the minutiae sets having a greater degree of alignment are selected based upon the scores for comparison to a similarity threshold. The process may be divided into several process segments including: preparation; registration; threshold comparison; neighbor matching; score; and optionally score boost processing steps, which are discussed more fully below with reference to FIG. 15.

In one embodiment, in FIG. 15, the search and file minutiae are prepared for comparison at blocks 510 and 512. Generally, both minutiae sets are normalized and scaled at this stage. The search print preparation is more detailed and involves the construction of various data structures, e.g., rotated search minutiae, neighbors of the search minutiae, look-up tables, etc. as discussed further below.

The search and file minutiae sets are sorted into descending tail angle order and the corresponding minutiae coordinates are scaled down. Minimum and maximum x and y coordinate values are also found for each file minutia. For each search minutiae, Nₙ nearest neighbors are located for using a summation of x and y differences between neighboring minutiae. In one embodiment, the number of neighbors is 8 if the number of neighboring minutiae is 9 or more. Otherwise, the number of neighbors is one less than the number of minutiae. Next, the search minutiae are rotated for several of angular orientations, N_{R}, and the rotated sets of minutiae are stored for the matching process. In one embodiment, the rotation is performed using integer arithmetic, and the nominal value of N_{R} is 10. Integer values stored in a look-up table are used for the coordinate rotation using sine and cosine functions.

In FIG. 15, at block 514, the registration stage comprises generally determining one or more best angle orientations and x, y offsets for aligning the search and file minutiae patterns. The search print is rotated and translated in N fixed positions. In one embodiment, the registration process is implemented using a histogram. Several orientations for aligning the minutiae of the file and search fingerprints are selected based upon differences in minutiae coordinate components, for example, based upon the highest frequency of differences in minutiae coordinate components. For each angular rotation, a two dimensional histogram of x, y translations is built to overlay all possible minutia pairs. In one embodiment, there is a matrix of histogram bins, for example, 64×64 bins, wherein each bin has 8-bits. The x, y translations corresponding to the histogram maximums, rotation angles for the maximum of all histograms, and the maximum value of all histograms, M*ₘ, is determined. The file print is compared with the N positions, and one or more registrations of the minutiae having the lowest error (i.e., highest overlay of the minutiae) are selected.

In FIG. 5, at block 516, for the one or more selected minutiae registrations having the lowest error, the number of paired minutiae is compared to a pre-determined threshold, which is based on empirical data. If the minutiae are matched poorly at block 518, a determination is made that there is not a fingerprint match and the matching process is terminated. In one embodiment, for example, the maximum value of all histograms, M*ₘ, is compared to a threshold, E_{T}. The threshold E_{T} is determined by empirically studying statistical distributions of histograms of matching and non-matching fingerprint features. The threshold should be selected to minimize processing of prints least likely to match. If M*ₘ does not exceed the threshold E_{T}, further fingerprint feature match processing is terminated. In FIG. 15, at block 520, a score is computed for the selected search orientations. Particularly, for each search orientation, a search anchor minutia and the nearest file anchor minutiae are determined (up to a maximum limit). Each such potential search-file minutia matched pair is further evaluated in terms of the similarity between their respective minutia neighbors. Particularly, for each search minutia having a matching file minutia, the search minutia is translated so the mating minutia coincides. The number, Nₙ, of nearest neighbors of the anchor search minutia also have corresponding mating file minutiae, Nₘ. For the matched neighbors, delta-x, delta-y, and delta-theta values are computed, and variances of the delta values are computed. The neighbor minutiae match is determined based upon a magnitude of the respective coordinate (x, y, theta) differences and based upon the variance. In one embodiment the (x, y) coordinate differences are weighted more heavily than the difference in theta since the x, y coordinates are known more precisely.

The similarity of minutia neighborhoods is quantified in terms of a score, called the mini-score, which is based upon the variances and the number, Nₘ, of the matched neighbors associated with the given search-file minutia pair. A list of the paired minutia together with the mini-scores is prepared and then pruned to create a 1-1 mapping (called the “hit-list”) between the search and file minutiae. In FIG. 15, at block 522, the sum of the mini-scores is reported as the hit-score for each orientation. Thus, a bi-level matching is implemented, first at the anchor level, and then at the neighbor level. Computationally, scoring can be described in terms of comparing minutia coordinates to calculate (fine-level) delta x, delta y and delta theta values, calculating the variance of the delta values, maintaining sorted lists of the matched minutiae, and pruning of the sorted lists to create a 1-1 mapping between the matched minutiae.

In some embodiments, for each best minutiae orientation that results in a sufficiently high hit-score, the density of the minutiae in neighborhood, for example, within a predefined radius, of a matched search minutia from the hit-list is determined. A similar calculation is made for the corresponding matched file minutiae. If the two density values agree, at least substantially, a boost for the matched pair is calculated, for example, based upon the degree of matching. A boost may also be calculated based upon a comparison of densities at different radii. The one or more boost computations are repeated for the all of the matched minutia pairs in the hit-list for the corresponding orientation. In FIG. 15, at block 524, the hit-score is added to the boost to obtain a boosted score. The maximum of the boosted score over all the orientations is reported as the match score.

At block 526, if the score for a particular orientation exceeds a score threshold, discussed further below, access is granted otherwise access is denied. In some cellular communications device applications, repeated failed access attempts, for example, within a specified time window, result in the transmission of the device location, for example, satellite positioning system or network based location information, to the network, which may deactivate the device in response.

As noted, the minutiae matching process is generally performed in stages, wherein each stage is characterized by input data, a set of operations on the input data, and an output. The output of one stage serves as the input to the next stage. Generally, data processing cannot begin at one stage until processing at the previous is complete. One exemplary hardware implementation is a pipelined processing architecture, which permits independent and concurrent operation on a complete set of data. Also, since completion times of the various stages may differ, buffers between stages may be used to facilitate load balancing and data sharing. Some of the input data, for example, minutiae coordinates, lookup tables, etc., and some intermediate results may be stored in RAM. In some instances, the same operation is performed on the same data, for example, the comparison of x, y, and theta data for minutia pairs. This is one instance of a single instruction multiple data (SIMD) operation. The hardware implementation may exploit the SIMD-type of parallelism inherent in the matching process.

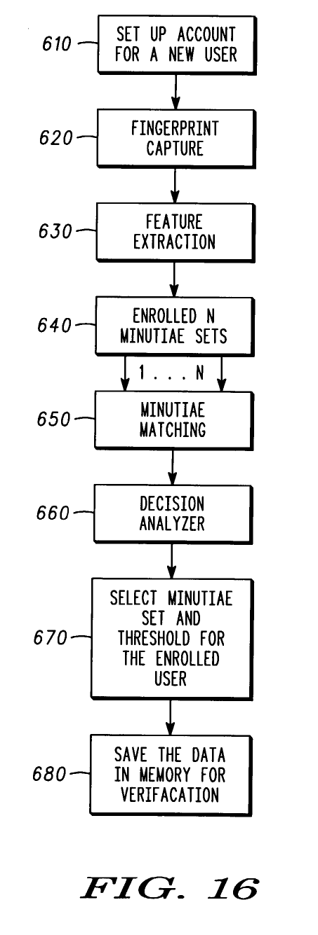

FIG. 16 is an exemplary fingerprint enrollment process flow diagram for generating one or more file or reference fingerprint features that may be used for matching search print features, as discussed above. The enrollment process may be performed at a service center or at other locations, and is generally not performed in the environment where the fingerprint security system is implemented, for example, on a wireless handset, where the fingerprint sensors are relatively small. Although in some applications, the file fingerprint may be scanned and the features extracted at any location. For instance, if memory and processing resources are not concerns, enrollment can be done at the device where the fingerprint security system is implemented. At block 610, a new user account is established for generating one or more file or reference fingerprint information that may be used for matching search print information, as discussed generally above. At block 620, the user's fingerprint is captured at a fingerprint sensor. At this stage, preferably, multiple images of the same fingerprint are captured, for example, at slightly different orientations. The fingerprint sensor used for enrollment is generally not limited by the same size and physical integrity constraints as in some applications, which were discussed above.

At block 630, fingerprint feature extraction is performed for each of the one or more images captured. Feature extraction includes one or more of identifying a thinned fingerprint image features, minutiae features, and fingerprint pattern features for each of the captured images, a more complete discussion of which was already presented above. Multiple minutia sets are extracted at block 640 for comparison.

At block 650, the selected minutiae of multiple impressions of the same fingerprint are matched using the same processes for matching file and search fingerprint information discussed above to compute at least one match score, which is used as the score threshold for the minutiae comparison process discussed above. Preferably, multiple match scores are computed based upon the comparison of multiple minutiae sets determined from separately captured images of the same fingerprint. The match scores may be computed as discussed above. Where multiple match scores are computed, in some applications, the lowest score is used as the score threshold. More generally, however, the match score threshold is chosen based upon the level of security required to meet a user-defined false acceptance rate (FAR) versus false rejection rate (FRR) ratio. For example, a banker may require a relatively low FAR, while a cell phone users may desire a relatively low FRR.

At block 660, the one or more minutiae sets and other features to be used for fingerprint verification are analyzed, and at block 670 a minutiae set, other fingerprint features, and an optimum score threshold are selected. At block 680, the fingerprint features and score threshold are stored in memory at a location where fingerprint matching will occur, for example at a network security server, or at a wireless communications handset. An archive copy may also be saved at an enrollment center. Transmission of fingerprint images, fingerprint feature information, score threshold and other information derived from and pertaining to fingerprints are preferably communicated and stored in encrypted form to ensure confidentiality.

Alternatively, the communication device 100 contains fingerprint capture and feature extraction tasks only. The enrollment and matching tasks are done in the infrastructure or service center. The fingerprint minutiae and other features as well as access decisions are transmitted wirelessly. As mentioned above, the transmitted information can be encrypted to ensure privacy.

While the present inventions and what are considered presently to be the best modes thereof have been described sufficiently to establish possession by the inventors and to enable those of ordinary skill to make and use the inventions, it will be understood and appreciated that there are equivalents to the exemplary embodiments disclosed herein and that many modifications and variations may be made thereto without departing from the scope and spirit of the inventions, which are to be limited not by the exemplary embodiments but by the claims appended hereto.

What is claimed is:

1. A handheld electronics device, comprising:
a housing;
a processor coupled to memory;
a plurality of at least two non-optical fingerprint detectors coupled to the processor,
the plurality of non-optical pressure sensitive fingerprint detectors disposed on the housing of the handheld electronics device and accessible from an outer side of the housing.

2. The handheld electronics device of claim 1 is a mobile wireless communications device, a wireless transceiver coupled to the processor.

3. The handheld electronics device of claim 1, the non-optical fingerprint detectors are pressure sensitive capacitive sensors.

4. A fingerprint information processing method, comprising:
capturing a fingerprint image having a plurality of pixels with corresponding intensity values;
increasing a range of intensity values of the fingerprint image pixels;
enhancing the fingerprint image having the increased range of intensity values;
identifying minutiae of the enhanced fingerprint image.

5. The method of claim 4, local contrast enhancing the fingerprint image before increasing a range of intensity values.

6. The method of claim 4, convolving the fingerprint image with a sinusoidally-modulated Gaussian kernel before increasing the range of intensity values.

7. The method of claim 4, enhancing the fingerprint image by iteratively performing pixel direction image estimation, pixel direction image enhancement, and pixel intensity enhancement, at least once.

8. The method of claim 4, binarizing the enhanced fingerprint image by performing a thresholding operation.

9. The method of claim 4, thinning the enhanced fingerprint image before identifying minutiae.

10. The method of claim 9, de-whiskering the thinned fingerprint image.

11. The method of claim 9, filling broken ridges of the enhanced fingerprint image before thinning.

12. The method of claim 4, breaking weak connections of the enhanced fingerprint image before thinning.

13. A fingerprint information processing method, comprising:
forming a fingerprint image comprising pixels;
identifying minutiae of the fingerprint image;
determining confidence information for each minutia,
the confidence information based on pixel direction in a neighborhood of each minutia, continuity of any ridges connected to each minutia, and continuity of ridges neighboring each minutia.

14. The method of claim 13, identifying false minutiae by comparing the confidence information of each minutia to a confidence threshold.

15. The method 14, dynamically changing the confidence threshold based on the number of minutiae detected.

16. The method of claim 13,
selecting a subset of minutiae based on the confidence information,
comparing the selected subset of minutiae to a reference subset of minutiae derived from a negative image of the fingerprint image,
eliminating minutiae from the selected subset of minutiae not having corresponding minutiae in the negative image.

17. The method of claim 13, enhancing the fingerprint image before detecting minutiae by iteratively performing at least one of gray-level statistics calculation, pixel direction image estimation, pixel direction image enhancement, and pixel intensity enhancement.

18. The method of claim 17, thinning the enhanced fingerprint image before detecting minutiae.

19. A fingerprint information processing method, comprising:
forming an enhanced fingerprint image comprised of pixels;
identifying minutiae of the fingerprint image;
determining confidence information for each minutiae;
comparing confidence information of the minutiae to a dynamically changing confidence threshold.

20. The method of claim 19, dynamically changing the confidence threshold based upon the number of minutiae detected.

21. A fingerprint information processing method, comprising:
forming a fingerprint image comprised of pixels;
identifying minutiae of the fingerprint image;
forming a negative image of the fingerprint image;
eliminating minutiae from the minutiae identified not having corresponding minutiae in a negative image of the fingerprint image.

22. The method of claim 21,
determining confidence information for each minutia;
selecting a subset of minutiae from the minutiae identified based on the confidence information by comparing the confidence information of the detected minutiae to a dynamically changing confidence threshold;
eliminating minutiae from the subset of minutiae not having corresponding minutiae in a negative image of the fingerprint image.

23. A fingerprint information processing method, comprising:
capturing a plurality of fingerprint images, each fingerprint image having a plurality of pixels with corresponding intensity values;
extracting minutiae from a binarization of each of the fingerprint images,
selecting minutiae extracted from at least two of the binarized fingerprint images;
determining a matching threshold based upon a comparison of the minutiae selected.

24. The method of claim 23, enhancing the fingerprint image by performing at least one of gray-level statistics calculation, pixel direction image estimation, pixel direction image enhancement, and pixel intensity enhancement, at least once.

25. The method of claim 23 thinning the enhanced fingerprint image before extracting minutiae.

26. A fingerprint information processing method, comprising:
determining alignment of file and search fingerprint minutiae for a plurality of orientations of the file and search fingerprint minutiae;
selecting at least one orientation of the file and search fingerprint minutiae having a greater degree of alignment than other orientations of the file and search fingerprint minutiae;
determining similarity between the file and search fingerprint minutiae by comparing a measure of the alignment of the at least orientation selected to a similarity threshold.

27. The method of claim 26, selecting orientations for aligning the file and search fingerprint minutiae based upon differences in minutiae coordinate components.

28. The method of claim 27, selecting orientations for aligning the file and search fingerprint minutiae based upon a highest frequency of differences in minutiae coordinate components.

29. The method of claim 26,
determining neighbor minutiae for each of the aligned file and search fingerprint minutiae for each orientation selected;
determining alignment of neighbor minutiae based upon a measured variance of neighbor minutiae.

30. The method of claim 29, determining alignment of neighbor minutiae based upon a comparison of neighbor minutiae density for aligned minutiae of the file and search fingerprints.

31. The method of claim 26,
determine a density of minutiae in a neighborhood of matched minutiae for each of the file and minutia fingerprints;
comparing the minutiae density of the file and search fingerprints.

32. A method in a wireless communications device, that communicates in communications networks, having a fingerprint security system, comprising:
capturing a fingerprint image at the mobile wireless communications device;
identifying fingerprint minutiae features from the fingerprint image;
matching the fingerprint minutiae features with the reference minutiae features;
providing access to the mobile wireless communications device based upon the matching of the fingerprint minutiae features with the reference minutiae features.

32. The method of claim 31, transmitting the fingerprint minutiae features to a network, determining whether the fingerprint minutiae features match reference minutiae features at the network.

33. The method of claim 31, determining confidence information for each of the minutia, disregarding minutia having confidence information less than a confidence threshold that changes dynamically based upon the number of minutiae extracted.

34. The method of claim 31,
determining confidence information for each minutia detected, the confidence information based on pixel direction in a neighborhood of each minutia, continuity of any ridges connected to each minutia, and continuity of ridges neighboring each minutia.

35. The method of claim 31, increasing a range of intensity values of the fingerprint image, enhancing the fingerprint image having the increased range of intensity values, identifying minutiae of the enhanced fingerprint image.

36. The method of claim 31, preventing access to the mobile wireless communications device with the fingerprint security system after a predetermined period of inactivity of the mobile wireless communications device.

37. The method of claim 31, forming a negative image of the fingerprint image, eliminating minutiae not having corresponding minutiae in a negative image of the fingerprint image.
